(19) United States
(12) Patent Application Publication
(10) Pub. No.: US 2021/0094072 A1
(43) Pub. Date: Apr. 1, 2021

(54) A SORTING MACHINE WITH A BIN CONVEYOR AND AN INCREASED NUMBER OF SORTING OUTLETS

(71) Applicant: SOLYSTIC, Bagneux (FR)

(72) Inventors: Karim Kara, Chabeuil (FR); Frederic Badier, Saint Peray (FR); Didier Tresse, Saint Laurent D'Olnay (FR); David Morisot, Beaumont les Valence (FR); Mohammed Ghezal, Tullins (FR)

(21) Appl. No.: 16/465,186

(22) PCT Filed: Feb. 28, 2019
(86) PCT No.: PCT/FR2019/050463

§ 371 Date: May 30, 2019

(30) Foreign Application Priority Data
Mar. 16, 2018 (FR) 1852260

(51) Int. Cl. B07C 3/00; B07C 3/08

(52) U.S. Cl. CPC B07C 3/008; B07C 3/08

(57) ABSTRACT

The mailpiece sorting machine includes a bin sorting conveyor (1) that acts under the control of a control unit (4) to move the bins (3) over sorting outlets (S1, S2, Sn) having removable storage trays (5). The control unit is suitable for detecting (20) that a current mailpiece has a destination address that does not correspond to an available sorting outlet in the machine. If such a situation is detected, a manipulator robot (R) comes to replace the tray of a sorting outlet with an empty tray (or with a tray already containing mail for the same destination address) into which the current mailpiece is sorted, while the replaced tray is placed on standby on a rack (8).

### TECHNICAL FIELD

The invention relates to the field of postal sorting machines.

The invention relates more particularly to a mailpiece sorting machine with a bin sorting conveyor that acts under the control of a control unit to move the bins over sorting outlets having removable storage trays so as to sort the mailpieces into the storage trays according to a certain sorting plan that associates destination addresses of the mailpieces with respective ones of said sorting outlets.

### PRIOR ART

Such sorting machines have sorting capacities that are determined by the number of sorting outlets present under the bin conveyor, and typically by the number of storage trays lined up in the sorting outlets.

Machines that are commercially available can currently have up to 480 sorting outlets lined up under the bin conveyor. Such a sorting machine having a bin conveyor occupies a large footprint on the floor, like the sorting machine disclosed in Document WO-A-2009/081008.

There exists a need to increase the sorting capacities of such a machine, but without, however, increasing its footprint. By way of example, a target is to make it possible to obtain 680 sorting outlets.

### SUMMARY OF THE INVENTION

The basic idea of the invention is that if a current mailpiece arrives in the bin conveyor without its destination address being served by an available sorting outlet, then a manipulator robot comes automatically to replace the tray of a sorting outlet (which tray may be partially filled) with an empty tray, and that sorting outlet is assigned to the destination address of said current mailpiece.

The idea is also for the tray that has been removed from the sorting outlet to be placed on standby on a rack by the shuttle robot so that said tray (which may contain mail) can be put back into a sorting outlet during the sorting process, if necessary by it replacing another sorting outlet tray.

The invention thus provides a mailpiece sorting machine with a bin sorting conveyor that acts under the control of a control unit to move the bins over sorting outlets having removable storage trays so as to sort the mailpieces into the storage trays according to a certain sorting plan that associates destination addresses of the mailpieces with respective ones of said sorting outlets, the control unit being suitable for detecting that a current mailpiece having a certain destination address cannot be sorted into a sorting outlet that is available for said destination address, the machine being characterized in that it also includes a manipulator robot suitable for moving along the sorting outlets and for performing a tray replacement, and in that the control unit is arranged so that it responds to said detection by identifying a certain sorting outlet from among the sorting outlets and by causing the manipulator robot to replace the tray of said certain sorting outlet with an empty tray (or with a tray already containing mail with the same destination address), the tray of said certain sorting outlet being placed on standby on a rack by the manipulator robot, and at the same time by updating the association between said certain destination address and said certain sorting outlet.

This arrangement contributes to increasing the separation capacity of the sorting machine having a bin conveyor by providing an increased number of sorting outlets. In accordance with the invention, it is possible to provide a plurality of manipulator robots that may optionally follow intersecting paths to perform a plurality of tray replacements at the same time.

The sorting machine of the invention may also have the following features:

It may include a rack for temporarily storing trays that is disposed above the bin conveyor and on which the trays on standby are placed.

The control unit may be arranged to select said certain sorting outlet from among the sorting outlets on the basis of a priority criterion based on the time for which the sorting outlets have remained unused or on the basis of a low-use criterion based on the ratio between the number of mailpieces present in the conveyor for the tray in place in the sorting outlet and the number of mailpieces present in the conveyor for the tray on standby.

It is also possible to use a priority criterion based on a ratio between the number of mailpieces present in the conveyor having an available destination.

It may include a tray conveyor suitable for conveying trays along the sorting outlets, said manipulator robot further being suitable for feeding the tray conveyor with trays filled with mailpieces and extracted from the sorting outlets or placed on standby on a rack.

An example of a sorting machine of the invention is shown in the drawings.

### BRIEF DESCRIPTION OF THE DRAWINGS

FIG. 1 is a highly diagrammatic view of a machine of the invention;

FIG. 2 shows how the manipulator robot is controlled;

FIG. 3 shows a correspondence table of the sorting plan; and

FIG. 4 shows a flat mailpiece with a destination address.

### DESCRIPTION OF EMBODIMENTS

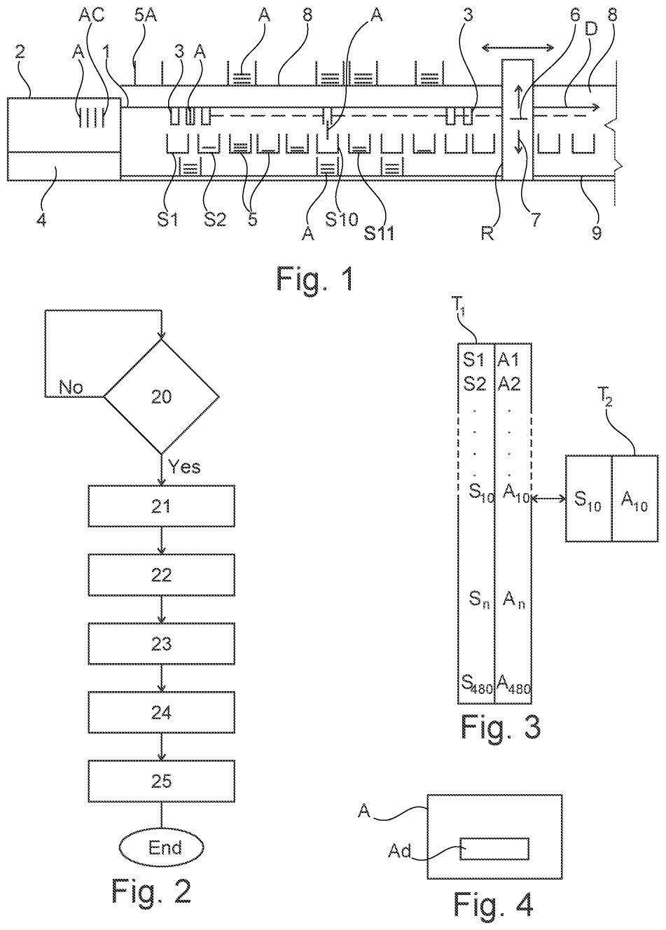

FIG. 1 is a highly diagrammatic side view of a mailpiece sorting machine of the invention that includes a bin conveyor 1 fed with mailpieces via a feed inlet 2, and, in this example, fed with one mailpiece per bin.

The mailpieces are referenced A, and the bins of the bin conveyor are referenced 3.

In this example, the bins 1 of the conveyor move in a closed loop in the direction indicated by arrow D.

The feed inlet 2 is suitable for identifying or recognizing the destination address of each mailpiece A loaded in a bin 3 of the conveyor 1, e.g. by optical identification or recognition as is well known.

On the basis of the optical recognition of the destination address Ad, e.g. as shown in FIG. 4 for a flat mailpiece A, the control unit 4 of the machine is suitable for triggering opening of the bin loaded with said mailpiece when said bin passes over the sorting outlet tray that constitutes the sorting tray associated with the destination address Ad of the mailpiece in the sorting plan.

FIG. 1 shows a series of removable storage trays 5 lined up under the bin conveyor 3, which trays constitute respective sorting outlets S1, S2, . . . , Sn for separating the mailpieces according to their destination addresses.

Associating the sorting outlets S1, S2, . . . , Sn in correspondence with the destination addresses is performed conventionally in a sorting plan that is shown here in the form of a correspondence table referenced T1 in FIG. 3.

In this example, the sorting outlets S1, S2, . . . , Sn are in correspondence with sorting data items A1, A2, . . . , An that are representative of groups of different destination addresses, with the distribution being a function of the desired sorting plan.

For example, the machine may have separation capacity for separating into 480 active sorting outlets that are constituted by respective storage trays 5 lined up under the bin conveyor 1.

In accordance with the invention, this separation capacity is increased without increasing the footprint of the machine, and this is achieved by means of a tray manipulator robot referenced R in FIG. 1 that is suitable for extracting a tray that is partially filled with mailpieces in a sorting outlet and replacing it with an empty tray (or with a tray that already contains mail having the same destination address), the replaced tray being placed on a rack 8 to stand by until it is put back by the manipulator robot R into a sorting outlet during the sorting process.

For example, if 120 additional empty trays are available, the separation capacity of the machine comes up to 600 sorting outlets.

For example, this manipulator robot R is designed with a telescopic fork 6 mounted on an elevator 7.

The manipulator robot R is arranged to move (e.g. by rolling or sliding) along the sorting outlets S1, S2, etc., under the control of the control unit 4, in such a manner as to be positioned facing a certain tray 5 of a sorting outlet chosen by the control unit 4.

The sorting outlet may be chosen by the control unit 4 on the basis of a priority criterion based on the time for which the sorting outlet has remained unused, i.e. the control unit 4 chooses the sorting outlet that is the least busy from among the active sorting outlets.

For example, busyness may be measured by counting the number of mailpieces stored in each sorting outlet tray.

More particularly, in accordance with the invention, the control unit 4 is arranged to detect (block 20 in FIG. 2), e.g. in the feed inlet 2, that a current mailpiece Ac arriving for loading into a bin 3 has a destination address Ad that is not served by any available sorting outlet (sorting outlet present in table T1) of the machine.

In such an event, and in response to such detection at 20, the control unit 4 determines, at 21, which sorting outlet is the most passive and should have its tray replaced with an empty tray.

At 22, the control unit 4 causes the manipulator robot 3 to move so that it is positioned facing said passive sorting outlet, e.g. the sorting outlet S10 in FIG. 1.

In step 23, the manipulator robot performs tray replacement: it extracts the partially filled tray 5, from the outlet S10 in this example, and raises it to the height of the rack 8 so as to place it on said rack.

The tray on the rack thus remains on standby, waiting to be put back into an active sorting outlet, or indeed to be removed at the end of the sorting process.

At 24, under the control of the control unit 4, the manipulator robot goes to pick up an empty tray (or a tray already containing mail having the same destination address as the current mail) that may be on standby on the rack 8, such as the tray 5A, and comes to place that tray 5A in the sorting outlet S10.

At 25, at the same time as the replacement process is taking place, the control unit updates the sorting plan, namely re-assigns correspondences in table T1 by putting the sorting outlet S10 provided with the tray into correspondence with the destination address Ad of the current mailpiece Ac as shown in FIG. 3.

Advantageously, the control unit 4 stores in a memory details of the three-dimensional position of the tray A10 placed on the rack in such a manner as to enable it to be automatically retrieved subsequently by the manipulator robot R.

Naturally, the entire process of tray replacement and of updating of the table T1 must be performed before the current article Ac arrives above the sorting outlet S10.

In this example, the rack 8 is a horizontal rack extending over the entire length of the line of sorting outlets. A segment of specific length of said rack may be reserved for storing empty trays.

The trays that are partially filled with mailpieces and that are put on standby on the rack may also be placed on a segment of specific length of said rack.

During the sorting process, if a current mailpiece is to be sorted, a tray put on standby on the rack may be put back into a sorting outlet, and thus the tray from said sorting outlet is put on standby on the rack.

Advantageously, the sorting machine may include a tray conveyor that serves to remove the trays filled with mailpieces either to an outlet of the sorting machine or to the feed inlet for the purpose of recycling the mailpieces for a new sorting pass.

The tray conveyor is given reference 9 in FIG. 1.

The manipulator robot R may advantageously be designed so that, under the control of the control unit 4, it replaces a tray filled with mailpieces in a sorting outlet with an empty tray, and places that full tray on the tray conveyor.

It may also be designed to transfer to the tray conveyor 9 a tray partially filled with mailpieces that is on the rack 8, in particular at the end of a sorting pass.

Advantageously, it is possible to provide a plurality of manipulator robots R that move along the sorting outlets under the control of the control unit 4. In such a situation, it is possible to consider making provision for said manipulator robots to serve different segments of the sorting outlets.

Advantageously, the invention extends to a sorting machine with a plurality of superposed bin conveyors.

Advantageously, the manipulator robot that replaces empty trays with full trays (or with partially full trays) may also be used during a machine preparation stage as a system for loading empty trays into the sorting outlets, thereby contributing to reducing the time required for loading the machine with empty trays.

1. A mailpiece sorting machine comprising:
a bin sorting conveyor that acts under the control of a control unit to move bins over sorting outlets having removable storage trays so as to sort mailpieces into the storage trays according to a certain sorting plan that associates destination addresses of the mailpieces with respective ones of said sorting outlets, the control unit being suitable for detecting that a current mailpiece having a certain destination address cannot be sorted into a sorting outlet that is available for said destination address, and
a manipulator robot suitable for moving along the sorting outlets and for performing a tray replacement,
wherein the control unit is arranged so that it responds to said detection by identifying a certain sorting outlet from among the sorting outlets and by causing the manipulator robot to replace the tray of said certain sorting outlet with an empty tray, or with a tray already containing mail with the same destination address, the tray of said certain sorting outlet being placed on standby on a rack by the manipulator robot, and at the same time by updating the association between said certain destination address and said certain sorting outlet.

2. The mailpiece sorting machine according to claim 1, wherein the mailpiece sorting machine includes the rack for temporarily storing trays that is disposed above the bin conveyor and on which the trays on standby are placed.

3. The mailpiece sorting machine according to claim 2, wherein said control unit is arranged to identify said certain sorting outlet on the basis of a priority criterion based on the time for which the sorting outlets have remained unused.

4. The mailpiece sorting machine according to claim 2, wherein said control unit is arranged to identify said certain sorting outlet on the basis of a low-use criterion based on the ratio between the number of mailpieces present in the conveyor for the tray in place in the sorting outlet and the number of mailpieces present in the conveyor for the tray on standby.

5. The mailpiece sorting machine according to claim 4, wherein the mailpiece sorting machine includes a tray conveyor suitable for conveying trays along the sorting outlets, said manipulator robot further being suitable for feeding the tray conveyor with trays filled with mailpieces and extracted from the sorting outlets or placed on standby on a rack.

6. The mailpiece sorting machine according to claim 1, wherein said control unit is arranged to identify said certain sorting outlet on the basis of a priority criterion based on the time for which the sorting outlets have remained unused.

7. The mailpiece sorting machine according to claim 1, wherein said control unit is arranged to identify said certain sorting outlet on the basis of a low-use criterion based on the ratio between the number of mailpieces present in the conveyor for the tray in place in the sorting outlet and the number of mailpieces present in the conveyor for the tray on standby.

8. The mailpiece sorting machine according to claim 3, wherein the mailpiece sorting machine includes a tray conveyor suitable for conveying trays along the sorting outlets, said manipulator robot further being suitable for feeding the tray conveyor with trays filled with mailpieces and extracted from the sorting outlets or placed on standby on a rack.

9. The mailpiece sorting machine according to claim 2, wherein the mailpiece sorting machine includes a tray conveyor suitable for conveying trays along the sorting outlets, said manipulator robot further being suitable for feeding the tray conveyor with trays filled with mailpieces and extracted from the sorting outlets or placed on standby on a rack.

10. The mailpiece sorting machine according to claim 1, wherein the mailpiece sorting machine includes a tray conveyor suitable for conveying trays along the sorting outlets, said manipulator robot further being suitable for feeding the tray conveyor with trays filled with mailpieces and extracted from the sorting outlets or placed on standby on a rack.
